(19) United States
(12) Patent Application Publication
(10) Pub. No.: US 2008/0080954 A1
(43) Pub. Date: Apr. 3, 2008

(54) COATED FASTENER

(76) Inventors: Gerald F. Snow, Almont, MI (US); James Patrick DeFillipi, Leonard, MI (US); Raymond Gerard Batura, Metamora, MI (US)

Correspondence Address: BLISS MCGLYNN, P.C., 2075 WEST BIG BEAVER ROAD, SUITE 600, TROY, MI, 48084, US

(21) Appl. No.: 11/635,327

(22) Filed: Dec. 7, 2006

Related U.S. Application Data
(63) Continuation of application No. 11/511,539, filed on Aug. 29, 2006.

(51) Int. Cl. F16B 35/04

(52) U.S. Cl. 411/424

(57) ABSTRACT

A coated fastener having a fastener and a coating disposed on a portion of the fastener. The coating is a liquid material applied to the fastener.

### CROSS-REFERENCE TO RELATED APPLICATION(S)

The present application is a continuation of U.S. Ser. No. 11/511,539, filed Aug. 29, 2006.

### BACKGROUND OF THE INVENTION

1. Field of the Invention

The present invention relates generally to coating fasteners and, more specifically, to an apparatus and method for coating fasteners.

2. Description of the Related Art

It is known to apply a coating to fasteners with an apparatus such as automated machinery. An example of such an apparatus is disclosed in U.S. Pat. No. 5,918,727 to Wallace et al. In this patent, the apparatus provides a barrier coating on a portion of discrete objects such as fasteners utilizing a liquid coating material. The apparatus introduces either a plurality of loose or interconnected parts onto a magnetized conveyor system and optically senses when parts are present. When parts are sensed, the sensor triggers a discrete shot of liquid coating material such as a fluorocarbon to be deposited onto a predetermined portion of each part. These parts can then be transferred to a second magnetized conveyor system that supports an opposite surface of the parts than the first conveyor for coating the fasteners.

Although the above-described apparatus has worked well, it does not work for non-ferrous fasteners. The apparatus uses magnetic devices that do not hold non-ferrous fasteners or holders that require hand placement and a delicate balance as to not upset the non-ferrous or non-magnetic fasteners. Also, the apparatus does not work for odd shaped fasteners. Further, the apparatus has a relatively low processing speed such as 2,500 fasteners per hour. Additionally, the apparatus does not work for depositing coating material into a recess of a fastener.

Therefore, it is desirable to provide to an apparatus and method for coating non-ferrous fasteners. It is also desirable to provide an apparatus and method for coating non-ferrous and odd shaped fasteners. It is further desirable to provide an apparatus and method for coating non-ferrous fasteners at relatively high processing speeds. It is still further desirable to provide an apparatus and method for coating a recess of fasteners. Thus, there is a need in the art to provide an apparatus and method that meets at least one of these desires.

### SUMMARY OF THE INVENTION

It is, therefore, one object of the present invention to provide an apparatus and method for coating non-ferrous fasteners.

It is another object of the present invention to provide an apparatus and method for coating odd shaped fasteners.

It is yet another object of the present invention is to provide an apparatus and method for coating fasteners at a relatively high processing speed.

It is still another object of the present invention to provide an apparatus and method that applies a coating material to a recess of a fastener.

To achieve one or more of the foregoing objects, the present invention is an apparatus for coating fasteners. The apparatus includes a conveyor having a pair of belts being laterally spaced to form a channel therebetween to receive a plurality of fasteners and at least one applicator located along the conveyor to apply a coating material to a portion of the fasteners. The belts have a first portion with a first durometer and a second portion with a second durometer greater than the first durometer.

Also, the present invention is a method for coating fasteners. The method includes the steps of providing a conveyor having a pair of belts being laterally spaced to form a channel therebetween. The belts have a first portion with a first durometer and a second portion with a second durometer greater than the first durometer. The method also includes the steps of receiving a plurality of fasteners in the channel and conveying the fasteners along the conveyor. The method further includes the steps of applying a coating material to a portion of the fasteners with at least one applicator located along the conveyor.

One advantage of the present invention is that an apparatus and method is provided for coating non-ferrous fasteners at a high rate of speed. Another advantage of the present invention is that the apparatus and method coats non-ferrous (such as stainless steel) fasteners and odd shaped fasteners not conveyed on existing equipment. Yet another advantage of the present invention is that the apparatus and method allows the use of standard vibratory feeding systems for fasteners that normally hang vertically by the heads and positions them into a dual durometer belt. Still another advantage of the present invention is that the apparatus and method can be adjusted horizontally for varying size diameter of the fasteners. A further advantage of the apparatus and method allows for processing speeds to greatly surpass current processing speeds, for example, in excess of 30,000 fasteners per hour compared to current processing speeds of 2,500 fasteners per hour. Yet a further advantage of the present invention is that the apparatus and method allows a coating material to be applied to a recess of a fastener in automated equipment.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a front elevational view of an apparatus, according to the present invention, for coating fasteners.

FIG. 2 is a plan view of a portion of the apparatus of FIG. 1.

FIG. 2A is enlarged plan view of a portion in circle 2A of FIG. 2.

FIG. 2B is enlarged plan view of a portion in circle 2B of FIG. 2.

FIG. 3 is an enlarged front elevational view of a portion in circle 3 of FIG. 1.

FIG. 4 is an enlarged side elevational view of the portion of the apparatus of FIG. 3.

FIG. 4A is an enlarged elevational view of a portion in circle 4A of FIG. 4.

FIG. 5 is a plan view of a portion of the apparatus of FIG. 4.

FIG. 6 is an enlarged front elevational view of a portion in circle 6 of FIG. 1.

FIG. 7 is an enlarged side elevational view of a portion of the apparatus of FIG. 6.

FIG. 7A is an enlarged side elevational view of a portion in circle 7A of FIG. 7.

FIG. 8 is a sectional view taken along line 8-8 of FIG. 6.

FIG. 9 is an enlarged front elevational view of a portion in circle 9 of FIG. 1.

FIG. 10 is a sectional view taken along line 10-10 of FIG. 9.

FIG. 11 is a front elevational view of another embodiment, according to the present invention, of the apparatus of FIG. 1.

### DESCRIPTION OF THE PREFERRED EMBODIMENT(S)

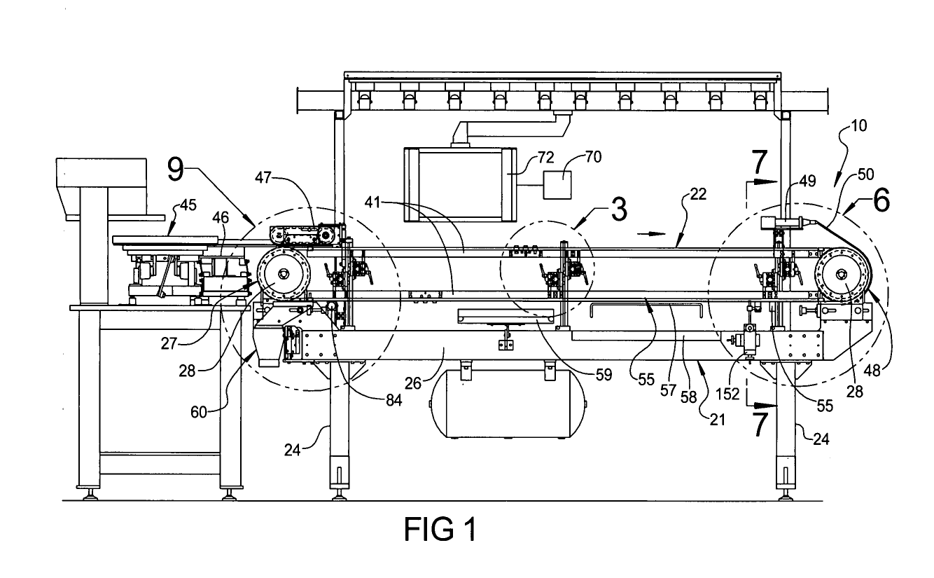

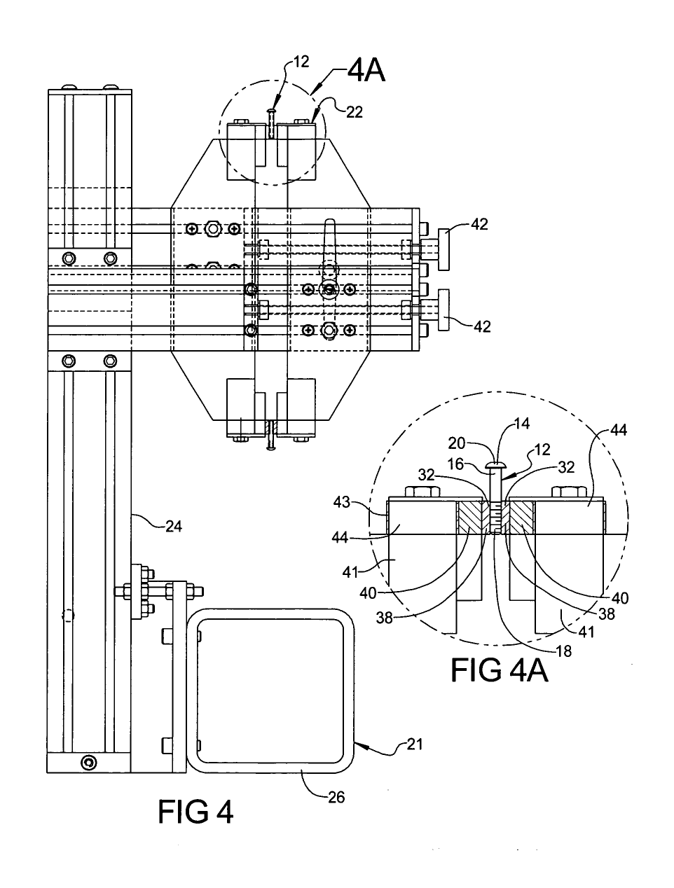

Referring now to the drawings, and in particular FIG. 1, one embodiment of an apparatus 10, according to the present invention, for coating fasteners, generally indicated at 12, is shown. The fasteners 12 are made of a non-magnetic or non-ferrous material such as stainless steel. The fasteners 12 may be of any suitable type or shape. As illustrated in FIG. 4A, in one embodiment, the fastener 12 has a head 14 extending radially and a shaft 16 extending axially from the head 14. In one embodiment, the fastener 12 has at least one, preferably a plurality of threads 18 disposed about and along the shaft 16. In one embodiment, the fastener 12 has a recess 20 extending axially into the head 14. It should be appreciated that the fastener 12, in other embodiments, may be odd shaped and that the threads 18 and recess 20 may be optional. It should be appreciated that the fasteners 12 are conventional and known in the art.

Referring to FIG. 1, the apparatus 10 includes a support frame, generally indicated at 21, to serve as a mounting base for a dual belt conveyor system, generally indicated at 22. The support frame 21 includes at least one, preferably a plurality of columns 24 and at least one, preferably a plurality of beams 26 connected together by a suitable mechanism such as brackets and fasteners.

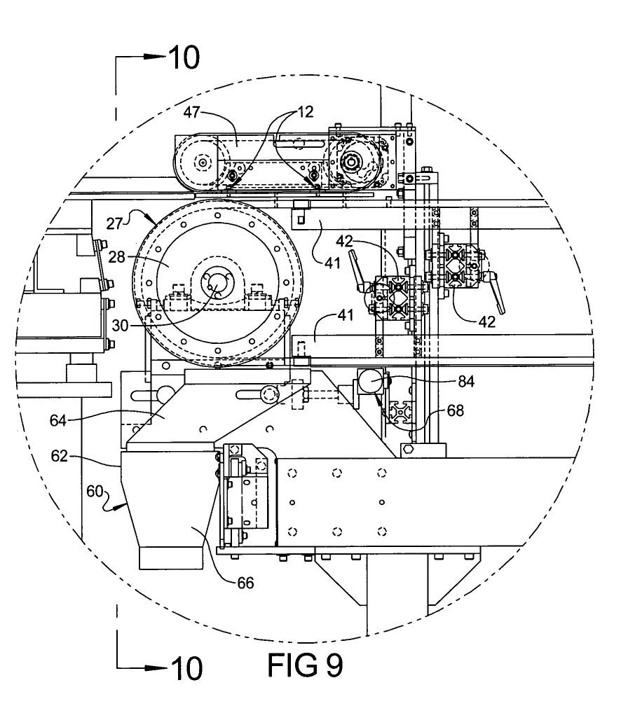

The apparatus 10 also includes a dual belt conveyor system 22 for conveying the fasteners 12. The dual belt conveyor system 22 includes a drive system, generally indicated at 27, for moving belts 32 to be described. In one embodiment, the drive system 27 includes a plurality of rotatable wheels 28 rotatably supported on the support frame 21. The wheels 28 are rotatably connected to one of the beams 26 by a suitable mechanism such as brackets and fasteners. Two of the wheels 28 oppose and are spaced laterally from each other at one end of the beam 26 and two of the wheels 18 oppose and are spaced laterally from each other at the other end of the beam 26 for a function to be described. The drive system 27 also includes a motor 29 (FIG. 9) connected to a rotatable shaft 30 on which opposed wheels 28 are rotatably mounted via a belt 31. The motor 29 is of a variable speed type and allows the speed of belts 32 to be selectively adjusted to a desired consistent speed. Depending upon the type of fasteners processed, the practical belt speed typically ranges from about 30 to about 60 feet/minute, thereby enabling production of 10,000 to more than 30,000 parts/hour by the present invention, depending upon the part, its shape, and size. It should be appreciated that the motor 29 is electrically connected to a source of power (not shown).

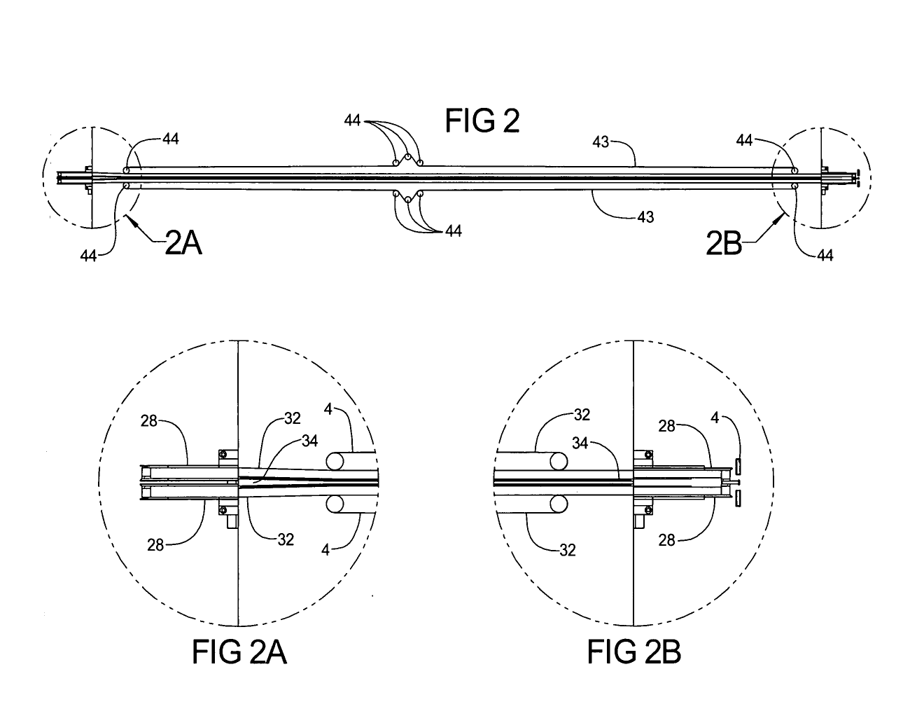

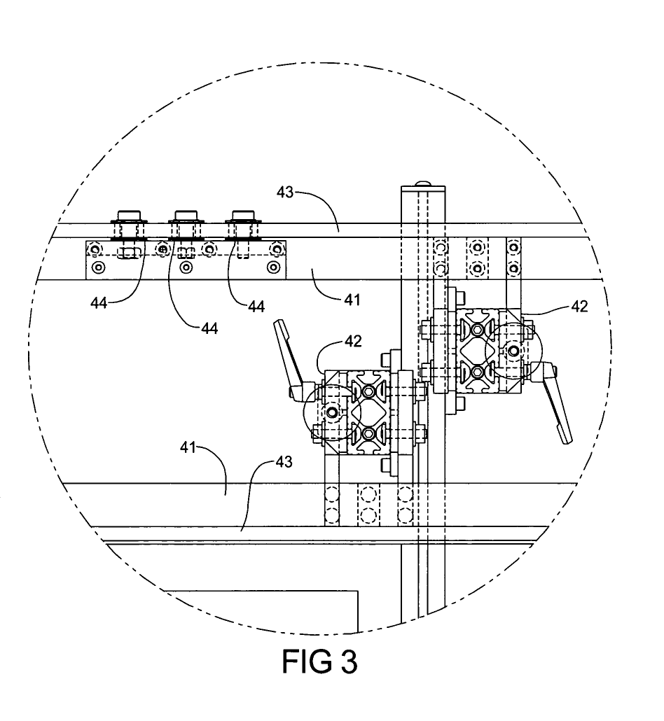

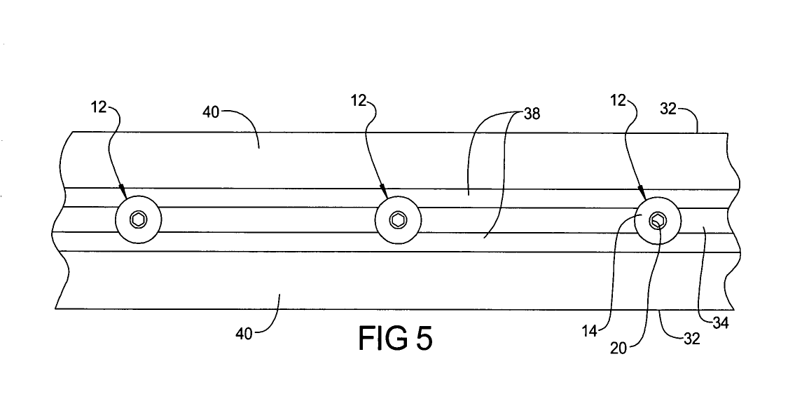

Referring to FIGS. 1 through 5, the dual belt conveyor system 22 includes at least one, preferably a plurality of belts 32 disposed about the wheels 28. One belt 32 is disposed about two longitudinally spaced wheels 28 and another belt 32 is disposed about the other two longitudinally spaced wheels 28. The belts 26 are spaced laterally to form an open channel or gap 34 therebetween for moving the fasteners 12. It should be appreciated that the wheels 28 and belts 32 can be readily removed from the conveyor system 22 to accommodate different types of fasteners 12.

The belts 32 are a laminate made of a dual durometer material. Each belt 32 has a first or lower durometer portion 38 such as a pliable, high temperature resistant non-conductive material or softer dual durometer material to grab or grasp the fastener 12 in a vertical orientation with the head 14 of the fastener 12 facing upwardly. The lower durometer portion 38 is in a range from about 20 Shore A to about 80 Shore A. Each belt 32 has a second or higher durometer portion 40 such as 70 Shore A to allow a stiffer dual durometer material such as silicone to act as the primary source of conveying the fasteners 12. The higher durometer portion 40 is in a range from about 40 Shore A to about 50 Shore D. The lower durometer portion 38 is adhered to the higher durometer portion 40 by a suitable means such as an adhesive. It should be appreciated that the use of silicone is preferred in belting as a result of the high temperatures that the fasteners 12 and belts 32 will experience. It should be appreciated that the belts 32 are continuous or closed-loop and traverse parallel in a horizontal plane.

The conveyor system 22 includes at least one, preferably a plurality of rails 41. The rails 41 are spaced laterally and vertically such that the rails 41 are adjacent the upper and lower portions of each of the belts 32. The rails 41 are connected to the columns 24 by a suitable mechanism such as brackets and fasteners. The conveyor system 22 includes at least one adjustment device 42 for moving the rails 41 to adjust a width of the channel 34 between the belts 32 for varying size diameter of the fasteners 12. In one embodiment, one of the rails 41 such as the rear rail is fixed and the laterally opposing rail 41 such as the front rail is adjusted by the adjustment device 42. It should be appreciated that the adjustment device 42 is manually operated to adjust the belts 32 by either spreading the belts 32 apart or moving them closer together. It should also be appreciated that the adjustment device 42 may be operated to adjust move the belts 32 up and down relative to each other. It should further be appreciated that the adjustment device 42 may be locked in place by a suitable mechanism such as a handle.

The conveyor system 22 also includes at least one, preferably a plurality of take-up belts 43 to maintain the belts 32 substantially straight and parallel to the support frame 21 while conveying fasteners 12 from one end of the conveyor system 22 to the other. One take-up belt 43 is disposed laterally adjacent each belt 32. The take-up belt 43 is a closed loop to provide a low coefficient of friction between the belt 32 and the rail 41. The conveyor system 22 also includes at least one, preferably a plurality of support rollers 44 mounted to the rails 41 and spaced along the side of the take-up belts 43 to provide support thereto and to adjust the tension or slack therein. It should be appreciated that the support rollers 44 are rotatably attached to the rails 71 by a suitable mechanism such as fasteners.

The gravity force exerted on each fastener 12 on the dual belt conveyor system 22 tends to hold the fastener 12 in frictional engagement substantially flat against the top surface of the belts 32 causing the fasteners 12 to move continuously along the belts 32 in a stable and fixed manner and at a consistent speed. No additional devices are needed to attach the fasteners 12 to the belts 32 during processing. It should be appreciated that the dual belt conveyor system 22 is very effective in providing a continuous stream of fasteners 12 in a very consistent position, thereby enabling coating materials to be applied to the fasteners 12 while using very high belt speeds.

The apparatus 10 also includes a feeder system, generally indicated at 45, positioned at one end of the dual belt conveyor system 22 to feed the fasteners 12 to the dual belt conveyor system 22. The fasteners 12 are orientated and aligned in a uniform manner by the feeder system 45. The feeder system 45 includes a vibratory feed bowl mechanism 45a. The feeder system 45 also includes a track mechanism 46 cooperating with the vibratory feed bowl mechanism 45a and the dual belt conveyor system 22. The track mechanism 46 is of a linear type. The linear track feed mechanism 46 separates the fasteners 12 from the vibratory feed bowl mechanism 45a and spaces the fasteners 12 for the conveyor system 22. The feeder system 45 further includes a belt mechanism 47 to move the fasteners 12 from the track mechanism 46 to engagement with the conveyor system 22. The belt mechanism 47 moves the fasteners 12 and holds the fasteners 12 generally perpendicular to the surface of the belts 32 of the conveyor system 22. In another embodiment, the fasteners 12 could be fed by hand to the dual belt conveyor system 22. It should be appreciated that the belt mechanism 47 has independent adjustment and is independently driven from the belts 32. It should also be appreciated that the feeder system 45 can take many different forms that are well known in the art.

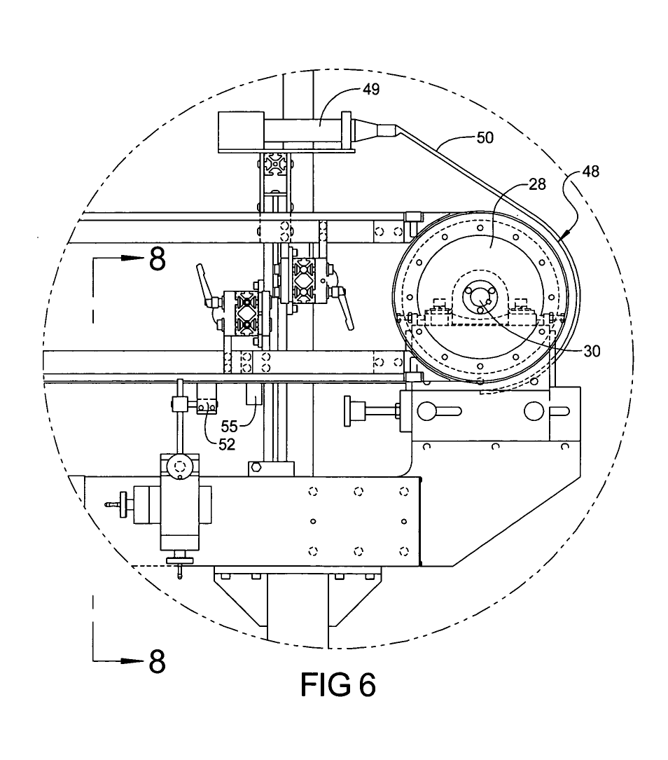

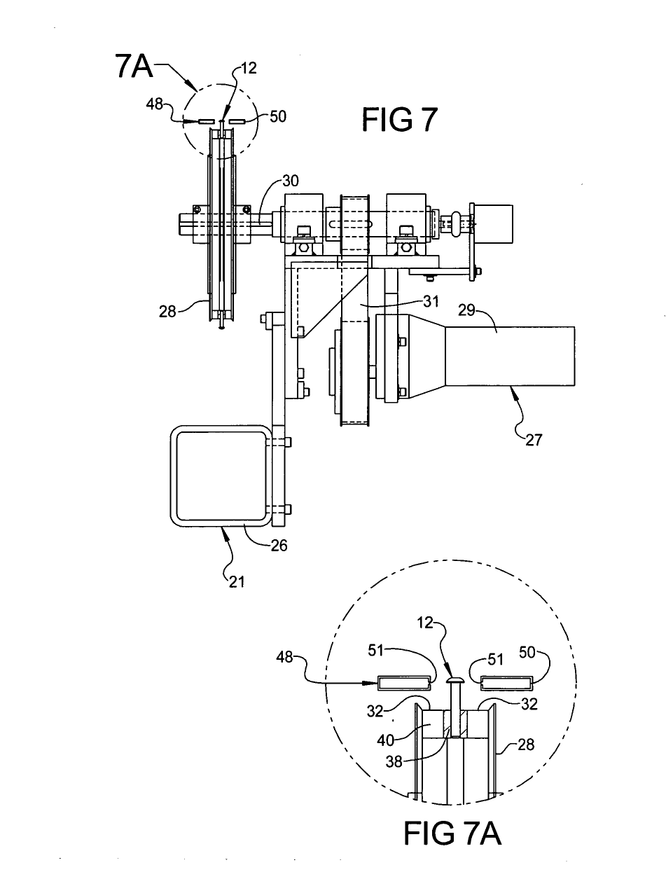

Referring to FIGS. 1, 6, 7, and 7A, the apparatus 10 also includes a heating device 48 positioned at the other end of the dual belt conveyor system 22. The heating device 48 is of a forced air type. The heating device 48 includes a blower 49 mounted to the frame 21 by a suitable mechanism such as brackets and fasteners. The blower 49 intakes air, heats the air, and discharges the heated air. The heating device 48 also includes a manifold 50 connected to the blower 49 to receive and distribute the heated air. The manifold 50 has a plurality of apertures 51 (FIG. 7A) therein to allow the heated air to be directed toward the fasteners 12. The fasteners 12 traverse along the length of the conveyor system 22 and continue onward over the wheels 28 and between the manifold 49 where the heated air heats the fasteners 12. The heating device 48 pre-heats the fasteners 12 to about 100° F. to about 150° F. prior to the application of any liquid coating materials. In certain limited instances, such pre-heating of the fasteners 12 may assist in the distribution of liquid coating material applied to the fasteners 12. It should be appreciated that, after the fasteners 12 are conveyed over the wheels 28, the fasteners 12 are now presented in a vertical fashion with the head 14 of the fastener 12 now in the downward position or facing downwardly.

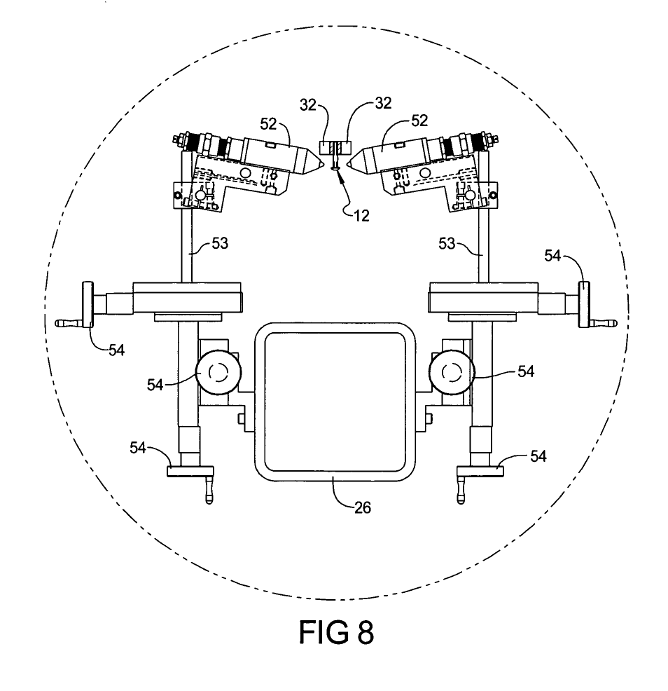

Referring to FIGS. 1, 6, and 8, the apparatus 10 includes at least one, preferably a plurality of applicators 52 for applying a coating to the fasteners 12. The applicators 52 are two dispensing modules on opposed sides of the fasteners 12 that release a preset or predetermined amount of material to a precise location. In one embodiment, the precise location is underneath the head 14 of the fastener 12. The applicators 52 used in connection with the present invention preferably utilize a nozzle diameter and range from about 0.005″ to about 0.040″ and are supplied with coating material under pressure of about 30 lbs/inch. Preferably, the applicators 52 are Nordson® gun modules of approximately 0.032 in size. Although a variety of different dispensing applicators can be utilized for the purpose of metering precise high speed discrete shots of liquid material, a particularly preferred gun has been found to be a Nordson® Zero Cavity Module with a Number 276515 module manufactured by the Nordson Corporation of Norcross, Ga. Again, although a variety of different stages can be used, a particularly preferred stage has been found to be the 4500 Series ballbearing stage manufactured by the Daedal Division of the Parker Corporation of Harrison City, Pa. It should be appreciated that the applicators 52 apply liquid coating materials to fasteners 12 that may have odd shapes, deep threads, extended threaded portions, off center openings, or are otherwise particularly difficult to completely or partially coat. It should also be appreciated that it is possible to use a single applicator 52 and a single shot of discrete material in connection with the present invention or any number of additional applicators 52 to deliver multiple discrete shots of material onto the fasteners 12. It is preferred that the applicators 52 be fully capable of applying at least 20,000 and preferably up to 50,000 discrete shots of material per hour.

The applicators 52 are supplied with liquid coating material from an off-line supply container (not shown). In one embodiment, the liquid coating material is an expandable sealant known as PLASTISEAL® that is commercially available from ND Industries, Inc., of Clawson, Mich. In another embodiment, the liquid coating material is a friction material known as DRIVE GRIP™ that is commercially available from ND Industries, Inc., of Clawson, Mich. It should be appreciated that the applicators 52 are capable of delivering high-speed accurate metered shots of a wide variety of liquid coating materials. It should also be appreciated that, in other embodiments, the liquid coating materials may include, but are not limited to, fluorocarbons, hydrocarbon and fluorocarbon copolymers, silicones, waxes, petroleum greases, Teflon™, sealant materials, and EEAs (ethylene/acrylic copolymer(s)).

The apparatus 10 includes at least one, preferably a plurality of adjustable support mounts 53 to support the applicators 52 on the support frame 21. The adjustable support mounts 53 have at least one, preferably a plurality of adjustment devices 54 that are moved in three dimensions, e.g., longitudinally, laterally, and vertically, to position the applicators 52 relative to the fastener 12. It should be appreciated that the adjustment devices 54 are manually operated.

The apparatus 10 includes at least one sensor 55 mounted to at least one of the support mounts 53 in close proximity to the applicators 52. The sensor 55 is of an optical type. When the sensor 55 senses a predetermined portion of the fastener 12, it triggers a discrete shot of the liquid coating material to be precisely delivered onto the predetermined location of the detected fastener 12. A particularly preferred sensor for this purpose has been found to be the model FX7 manufactured by Sunx Sensors Corporation. An alternative preferred sensor has been found to be the model no. PZ-101 manufactured by Keyance Corporation. It should be appreciated that the location, speed and amount of material that is deposited are controllable by the applicators 52 acting in combination with the sensor 55. It should also be appreciated that the sensor 55 is conventional and known in the art.

Referring to FIG. 1, the apparatus 10 includes a curing device, generally indicated at 56, to cure the liquid coating material on the fasteners 12. The curing device 55 includes at least one heater 57 to heat the fasteners 12 after the application of the liquid coating material. The heater 57 is of an induction coil type. The heater 57 heats the fasteners 12 such that the coating material on the fasteners 12 cures from the inside to bond the coating material to the fasteners 12. The curing device 56 may include a shield 58 disposed below the heater 57 and connected to the frame 21. The shield 58 is of a copper type. The shield 21 prevents heating of the frame 21 by the heater 57. It should be appreciated that, after the application of coating material is deposited on the fasteners 12, the heater 57 raises the temperature of the fasteners 12 to an elevated temperature such as 350° F. It should also be appreciated that the heater 57 is conventional and known in the art.

The curing device 56 also includes least one, preferably a plurality of lamps 59. The lamps 59 are of a Quartz type that can be varied in temperature and intensity. The lamps 59 cure the outside of the coating material on the fasteners 12. It should be appreciated that, after exiting the heater 57, the heated fasteners 12 are subjected to a final post cure process by the lamps 59. It should also be appreciated that, upon exiting the lamps 59, the fasteners 12 may or may not be subjected to water/oil quench mode, the application of water/oil being subjected to customer requirements.

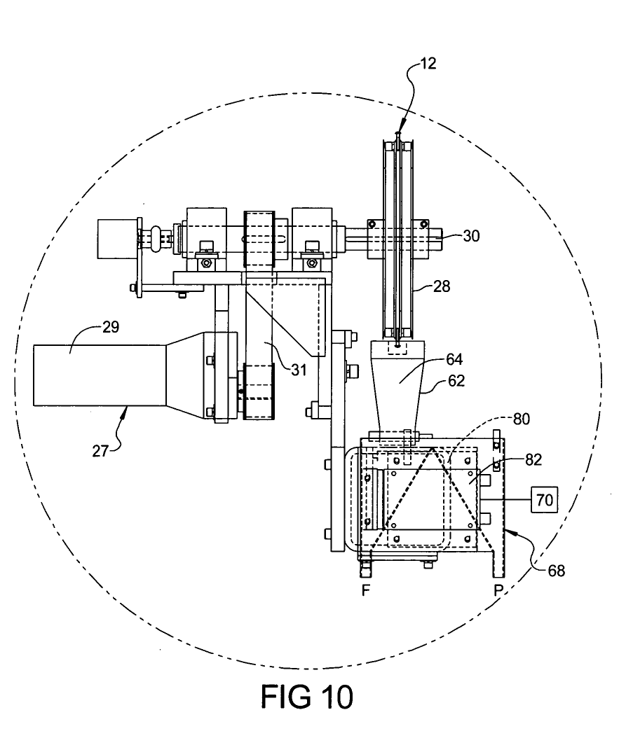

Referring to FIGS. 1, 9, and 10, the apparatus 10 includes a removal assembly, generally indicated at 60, located at the end of the conveyor system 22. The removal assembly 60 includes a deflection chute 62 disposed below one pair of the wheels 28. The deflection chute 62 has a top portion 64 that is generally rectangular in cross-sectional shape. The deflection chute 62 has a bottom portion 66 that is funneled shaped for a function to be described. The deflection chute 62 is connected to the support frame 21 by suitable means such as brackets and fasteners.

The apparatus 10 includes an inspection system, generally indicated at 68, for inspecting the coated fasteners 12 to reject or pass coated fasteners 12. The inspection system 68 includes a controller 70 for controlling the inspection process. The controller 70 includes a microprocessor, memory, and input/output. The inspection system 68 includes an input device 72 such as an operator touch screen electrically connected to the controller 70. The inspection machine 10 includes a display 74 electrically connected to the controller 70 to display the output of the controller 70. The display 76 is connected to the frame 21 by a suitable mechanism such as an arm member 78.

The inspection system 68 includes a movable diverter 80 disposed between the deflection chute 62. The diverter 80 has a generally inverted “V” shape. The diverter 80 is disposed below the bottom of the deflection chute 62. As illustrated in FIG. 9, the deflection chute 62 is shown in a pass position. The diverter 80 is connected to an actuator 82 by a suitable mechanism such as fasteners. The actuator 82 is of a pneumatic type. It should be appreciated that the actuator 82 is connected to a source of air (not shown) and that the controller 70 controls actuation of the actuator 82. It should also be appreciated that the actuator 82 moves the deflection chute 62 laterally between the pass position and the fail position.

The inspection system 68 includes at least one inspection camera 84 for inspecting the fasteners 12. As illustrated, the inspection camera 84 is disposed below the belts 32 and is supported by the frame 21 by a suitable mechanism such as brackets and fasteners. The inspection camera 84 is electrically connected to the controller 70. The inspection camera 84 takes a digital image of each fastener 12 and is sent to the controller 70. It should be appreciated that the controller 70 receives the image from the inspection camera 84 and determines whether each fastener 12 passes or fails a predetermined criteria and positions the diverter 80 to the corresponding position.

In one embodiment of operation of the apparatus 10, parts such as fasteners 12 are loaded into the feeder 45. The parts are fed from the feeder 45 to the track mechanism 46 and belt mechanism 47 and into the gap 34 between the belts 32. Each of the belts 32 has a dual durometer to grab the fastener 12 in a vertical fashion with the head 14 thereof facing upwardly and disposed above the belts 32. The drive system 27 moves the belts 32 longitudinally, thereby moving the fasteners 12 toward the heating device 48. It should be appreciated that the fasteners 12 are moved by the belts 32.

The fasteners 12 move through the manifold 50 of the heating device 48 and are heated by the heated air from the blower 49. The fasteners 12 are moved by the belts 32 over the wheels 28 and are presented with the heads 14 facing downwardly. The fasteners 12 are sensed by the sensor 58 and the applicators 52 are activated to release a predetermined amount of coating material to a precise location underneath the head 14 of the fastener 12. It should be appreciated that the fasteners 12 are moved by the belts 32 toward the curing device 68.

The fasteners 12 pass by the heater 57 and the heater 57 heats the fasteners 12 to an elevated temperature to bond and partially cure the coating material to the fasteners 12. After the heater 57, the fasteners 12 pass by the lamps 59 and the lamps 59 cure the outside of the coating material. After the curing device 68, the fasteners 12 pass by the inspection camera 84 and the inspection camera 84 takes a digital image of each fastener 12 and is sent to the controller 70.

Upon reaching the other wheels 28, the fasteners 12 exit the belts 32 near the bottom of the wheels 28 due to the increased width of the gap 34. The fasteners 12 are directed by the deflection chute 62 toward a collector (not shown). The controller 70 controls the movement of the diverter 80. If the controller 70 determines that the fastener 12 has passed inspection, the diverter 80 will be in a pass position. The fastener 12 will contact one side of the diverter 80 and fall into one side of the collector. If the controller 70 determines that the fastener 12 has not passed inspection, the controller 70 will send a signal to the actuator 82 and move the diverter 80 laterally to a failed position. The fastener 12 will contact the other side of the diverter 80 and fall into a second portion of the collector. It should be appreciated that the default position is the failed position.

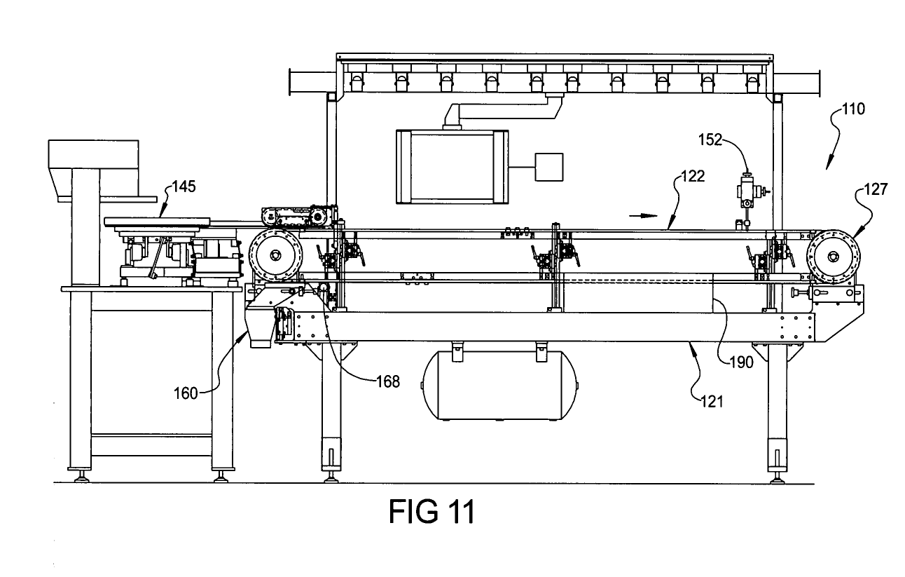

Referring to FIG. 11, another embodiment, according to the present invention, of the apparatus 10 is shown. Like parts of the apparatus 10 have like reference numerals increased by one hundred (100). In this embodiment, the apparatus 110 includes the support frame 121, dual belt conveyor system 122, drive system 127, and feeder system 145, but eliminates the heating device and curing device. The apparatus 110 includes at least one, preferably a plurality of applicators 152 for applying a coating to the fasteners 12. The applicators 152 are two dispensing modules on opposed sides of the fasteners 12 that release a preset or predetermined amount of material to a precise location. In one embodiment, the precise location is the recess 20 in the head 14 of the fastener 12. The applicators 152 are disposed above the belts 132. It should be appreciated that, in this embodiment, the apparatus 110 may be used for ferrous fasteners such as deck screws and drywall screws.

The applicators 152 are supplied with liquid coating material from an off-line supply container (not shown). In one embodiment, the liquid coating material is a carrier that is solvent or water based that will later receive a frictional material. In one embodiment, the friction material is known as DRIVE GRIP™ that is commercially available from ND Industries, Inc., of Clawson, Mich.

The apparatus 110 also includes a fluidized bed 190 disposed below the belts 132. The fluidized bed 190 is supplied with a friction material such as a dry powder material. As the fastener 12 rotates about the conveyor system 122, the head 14 of the fastener 12 is now presented vertically, but with the head 14 facing down. Because the fastener 12 is now presented vertically with the head 14 down, the head 14 of the fastener 12 will pass into the fluidized bed 190 and the frictional material will then be deposited into the recess 20 in the head 14 of the fastener 12. It should be appreciated that the frictional material or part two of the coating material is held in place by the liquid carrier or part one of the coating material. It should also be appreciated that the apparatus 110 may include post-heat and forced ambient air to “flash” cure the carrier.

The apparatus 110 also includes the removal assembly 160 located at the end of the conveyor system 122. The apparatus 110 further includes the inspection system 168 for inspecting the coated fasteners 12 to reject or pass coated fasteners 12. It should be appreciated that the apparatus 110 inspects and removes coated fasteners 12 similar to the apparatus 10 previously described.

In operation of the apparatus 110, the fasteners 12 are loaded into the feeder system 145. The parts are fed from the feeder system 145 and into the dual belt conveyor system 122. In one embodiment, the head 14 of the fasteners 12 is disposed above the belts of the dual belt conveyor system 122. It should be appreciated that the fasteners 12 are gripped by the dual belt conveyor system 122 and moved therealong.

With the head 14 of the fastener 12 presented up, a first part of the coating material such as a liquid carrier is applied. Because the fastener 12 is now presented vertically with the head 14 up, the liquid carrier flows into the recess 20 in the head 14 of the fastener 12. As the fastener 12 rotates about the conveyor system 122, the head 14 of the fastener 12 is now presented vertically, but with the head 14 facing down. The head 14 of the fastener 12 is moved through the fluidized bed 190 containing the second part of the coating material, a frictional material such as a dry powder material. Once this is achieved, the fastener 12 passes into the fluidized bed 190 and the frictional material will then be deposited into the recess 20. The frictional material is held in place by the carrier or part one of the coating material. Post-heat and forced ambient air will “flash” cure the solvent leaving the frictional material to act as the “drive grip”. The fasteners 12 then exit the apparatus 110 via the removal assembly 160.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A coated fastener comprising:
a fastener made of a non-magnetic material and having a head; and
a coating disposed on a portion below said head of said fastener, said coating comprising a liquid material applied to said fastener.

2. (canceled)

3. A coated fastener as set forth in claim 1 wherein said non-magnetic material is stainless steel.

4. A coated fastener as set forth in claim 1 wherein said fastener has a said head extending radially and a shaft extending axially from said head.

5. A coated fastener as set forth in claim 4 wherein said fastener has a plurality of threads disposed about and along said shaft.

6. A coated fastener as set forth in claim 4 wherein said fastener has a recess extending axially into said head.

7. (canceled)

8. A coated fastener comprising:
a fastener made of a non-magnetic material and having a head and a recess extending axially into said head;
a coating disposed in said recess; and
wherein said coating comprises a carrier and a frictional powder material.

9. A coated fastener as set forth in claim 8 wherein said carrier is one of a solvent and a water based liquid.

10. A coated fastener as set forth in claim 8 wherein said frictional material comprises a dry powder material.

11. (canceled)

12. (canceled)

13. A coated fastener as set forth in claim 1 wherein said coating is one of a fluorocarbon, hydrocarbon and fluorocarbon copolymer, silicone, wax, petroleum grease, Teflon™, sealant material, and ethylene/acrylic copolymer.

14. A coated fastener comprising:
a fastener made of a non-magnetic material and having a head extending radially, a shaft extending axially from said head, and a plurality of threads disposed about and along said shaft; and
a coating disposed on a portion below said head of said fastener, said coating comprising a liquid material applied to said fastener, wherein said liquid material dries on said fastener.

15. A coated fastener as set forth in claim 14 wherein said fastener has a recess extending axially into said head.

16. (canceled)

17. A coated fastener as set forth in claim 14 wherein said coating comprises a carrier and a frictional powder material.

18. A coated fastener as set forth in claim 17 wherein said carrier is one of a solvent and a water based liquid.

19. A coated fastener as set forth in claim 17 wherein said frictional material comprises a dry powder material.

20. (canceled)

21. A coated fastener as set forth in claim 14 wherein said non-magnetic material is stainless steel.

22. A coated fastener as set forth in claim 14 wherein said coating comprises an expandable sealant.

23. A coated fastener as set forth in claim 21 wherein said coating comprises PLASTISEAL®.

24. A coated fastener as set forth in claim 14 wherein said coating is one of a fluorocarbon, hydrocarbon and fluorocarbon copolymer, silicone, wax, petroleum grease, Teflon™, sealant material, and ethylene/acrylic copolymer.

25. A coated fastener comprising:
a fastener having a head extending radially, a shaft extending axially from said head, a plurality of threads disposed about and along said shaft, and a recess extending axially into said head; and
a coating disposed in said recess of said fastener, said coating comprising a carrier and a frictional powder material.

26. A coated fastener as set forth in claim 25 wherein said carrier is one of a solvent and a water based liquid.

27. A coated fastener as set forth in claim 25 wherein said frictional material comprises a dry powder material.

28. A coated fastener comprising:
a fastener made of a non-magnetic material and having a head extending radially, a shaft extending axially from said head, and a plurality of threads disposed about and along said shaft; and
a coating disposed on a portion of said threads of said fastener, said coating is one of a fluorocarbon, hydrocarbon and fluorocarbon copolymer, silicone, wax, petroleum grease, Teflon™, sealant material, and ethylene/acrylic copolymer, wherein said coating is applied as a liquid and dries on said fastener.

29. A coated fastener as set forth in claim 28 wherein said non-magnetic material is stainless steel.

30. A coated fastener as set forth in claim 28 wherein said sealant material comprises an expandable sealant.
